(19) United States
(12) Patent Application Publication
(10) Pub. No.: US 2005/0248325 A1
(43) Pub. Date: Nov. 10, 2005

(54) Voltage regulator with improved power supply rejection ratio characteristics and narrow response band

(75) Inventor: Masahiro Adachi, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: NEC ELECTRONICS CORPORATION

(21) Appl. No.: 11/117,528

(22) Filed: Apr. 29, 2005

(30) Foreign Application Priority Data
Apr. 30, 2004 (JP) 2004-135112

(51) Int. Cl. G05F 1/40

(52) U.S. Cl. 323/273

(57) ABSTRACT

In a voltage regulator, a reference voltage generating circuit generates a reference voltage. A drive transistor is connected between a first power supply terminal and an output terminal and has a control terminal. A voltage divider generates a feedback voltage which is an intermediate voltage between voltages at the output terminal and a first power supply terminal. A differential amplifier generates an error voltage in accordance with the feedback voltage of the voltage divider and the reference voltage, and transmits it to the control terminal of the drive transistor. An oscillation preventing capacitor is connected between the control of the drive transistor and the output terminal. A capacitor is connected between the first power supply terminal and the first input of the differential amplifier.

### BACKGROUND OF THE INVENTION

1. Field of the Invention

The present invention relates to a voltage regulator having improved power supply rejection ratio (PSRR) characteristics while maintaining a narrow response band.

2. Description of the Related Art

Voltage regulators have been incorporated in mobile stations such as mobile telephone sets or electronic notebooks which need to be small both in size and power consumption.

In a first prior art voltage regulator (see: FIG. 2 of JP-10-260741-A), a reference voltage generating circuit generates a reference voltage. A drive transistor is connected between a power supply terminal and an output terminal and has a control terminal. A voltage divider generates a feedback voltage which is an intermediate voltage between voltages at the output terminal and the ground terminal. A differential amplifier generates an error voltage in accordance with the feedback voltage of the voltage divider and the reference voltage, and transmit it to the control terminal of the drive transistor. An oscillation preventing capacitor is connected between the control of the drive transistor and the output terminal. This will be explained later in detail.

In the above-described first prior art voltage regulator, since the circuit current of the differential amplifier is relatively small and the capacitance of the oscillation preventing capacitor is relatively large, the response band is so narrow that the operation is stable. However, if a high frequency noise higher than a predetermined value is applied to the power supply voltage, the PSRR characteristics deteriorate rapidly, so that such a high frequency noise cannot be compensated for by the negative feedback control. As a result, such a high frequency noise would appear at the output terminal.

In the above-described first prior art voltage regulator, in order to improve the PSRR characteristics at a higher frequency, one approach to is increase the circuit current of the differential amplifier, and another approach is to decrease the oscillation preventing capacitor. In this case, however, the response band is also broadened, so that the operation would be unstable. Also, the former approach would increase the power consumption.

In a second prior art voltage regulator (see: JP-2001-159922-A), differential amplifiers (operational amplifiers) are added to the elements of the above-described first prior art voltage regulator. This also will be explained later in detail. As a result, the amplification of a differential amplifier section formed by the differential amplifiers is increased to improve the PSRR characteristics.

Even in the above-described second prior art voltage regulator, however, the response band would be broadened. Also, since the number of differential amplifiers (operational amplifiers) is increased, the power consumption would be increased and the circuit size would be increased.

### SUMMARY OF THE INVENTION

It is an object of the present invention to provide a voltage regulator having improved PSSR characteristics while maintaining the narrow response band, and capable of being incorporated into a mobile station which needs to be small both in size and power consumption.

According to the present invention, in a voltage regulator, a reference voltage generating circuit generates a reference voltage. A drive transistor is connected between a first power supply terminal and an output terminal and has a control terminal. A voltage divider generates a feedback voltage which is an intermediate voltage between voltages at the output terminal and a first power supply terminal. A differential amplifier generates an error voltage in accordance with the feedback voltage of the voltage divider and the reference voltage, and transmits it to the control terminal of the drive transistor. An oscillation preventing capacitor is connected between the control of the drive transistor and the output terminal. A capacitor is connected between the first power supply terminal and the first input of the differential amplifier.

The capacitor passes a high frequency noise higher than a predetermined value which is determined by a response band formed by a negative feedback control of the drive transistor and the differential amplifier. Therefore, the capacitor passes such a high frequency noise to the negative feedback control to improve the PSRR characteristics. Note that, since the capacitor in not within the negative feedback control, the capacitor does not broaden the response band of the negative feedback control.

### BRIEF DESCRIPTION OF THE DRAWINGS

The present invention will be more clearly understood from the description set forth below, as compared with the prior art, with reference to the accompanying drawings, wherein:

FIG. 1 is a circuit diagram illustrating a first prior art voltage regulator;

FIG. 2A is a graph showing the gain characteristics of the voltage regulator of FIG. 1 where the circuit current of the differential amplifier is relatively small and the capacitance of the oscillation preventing capacitor is relatively large;

FIG. 2B is a graph showing the PSRR characteristics of the voltage regulator of FIG. 1 where the circuit current of the differential amplifier is relatively small and the capacitance of the oscillation preventing capacitor is relatively large;

FIG. 3A is a graph showing the gain characteristics of the voltage regulator of FIG. 1 where the circuit current of the differential amplifier is relatively large or the capacitance of the oscillation preventing capacitor is relatively small;

FIG. 3B is a graph showing the PSRR characteristics of the voltage regulator of FIG. 1 where the circuit current of the differential amplifier is relatively large or the capacitance of the oscillation preventing capacitor is relatively small;

FIG. 4 is a circuit diagram illustrating a second prior art voltage regulator;

FIG. 5 is a circuit diagram illustrating a first embodiment of the voltage regulator according to the present invention;

FIG. 6A is a graph showing the gain characteristics of the voltage regulator of FIG. 5 where the circuit current of the differential amplifier is relatively small and the capacitance of the oscillation preventing capacitor is relatively large;

FIG. 6B is a graph showing the PSRR characteristics of the voltage regulator of FIG. 5 where the circuit current of the differential amplifier is relatively small and the capacitance of the oscillation preventing capacitor is relatively large;

FIG. 7 is a circuit diagram illustrating a second embodiment of the voltage regulator according to the present invention;

FIG. 8 is a circuit diagram illustrating a third embodiment of the voltage regulator according to the present invention;

FIG. 9 is a circuit diagram illustrating a fourth embodiment of the voltage regulator according to the present invention; and

FIG. 10 is a circuit diagram illustrating a modification of the voltage regulator of FIG. 5.

### DESCRIPTION OF THE PREFERRED EMBODIMENTS

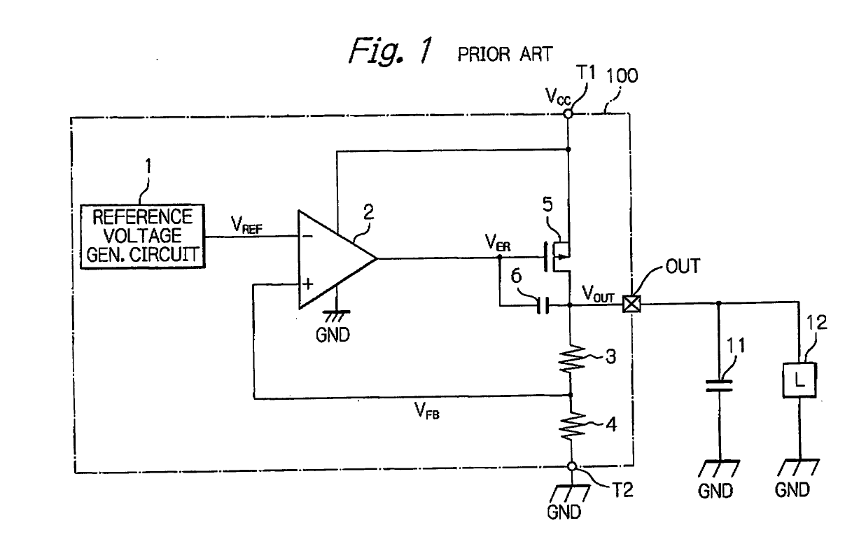

Before the description of the preferred embodiments, a prior art voltage regulator will be explained with reference to FIGS. 1, 2A, 2B, 3A, 3B and 4.

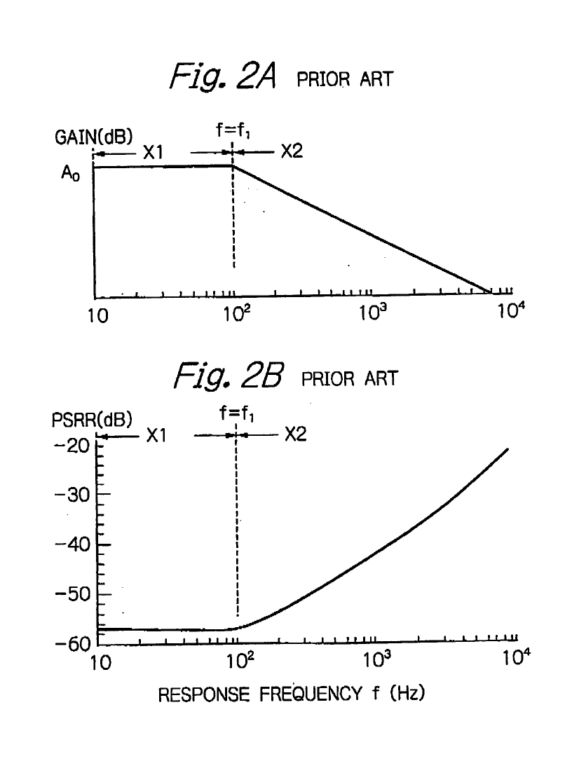

In FIG. 1, which illustrates a first prior art voltage regulator 100 (see: FIG. 2 of JP-10-260741-A), a reference voltage generating circuit 1 generates a reference voltage V_{REF} and applies it to a negative input of a differential amplifier (operational amplifier) 2 whose positive input receives a feedback voltage V_{FB} from a voltage divider formed by resistors 3 and 4.

The differential amplifier 2 whose circuit current is relatively small generates an error voltage V_{ER} in accordance with a difference between the feedback voltage V_{FB} and the reference voltage V_{REF} and applies it to a gate of a drive P-channel MOS transistor 5. As a result, the drive P-channel MOS transistor 5 generates an output voltage V_{OUT} at its drain, i.e., at an output terminal OUT.

An oscillation preventing capacitor 6 whose capacitance is relatively large is connected between the gate and drain of the drive P-channel MOS transistor 5.

An external capacitor 11 and an external load 12 are connected to the output terminal OUT.

A power supply voltage V_{CC} and a ground voltage GND are applied to terminals T1 and T2, respectively, where a series of the drive P-channel MOS transistor 5 and the resistors 3 and 4 are connected.

In FIG. 1, a negative feedback control is carried out, that is, the output voltage V_{OUT} is fed back as the feedback voltage V_{FB} via the differential amplifier 2 to the gate of the drive P-channel MOS transistor 5, so that the fluctuation of the output voltage V_{OUT} can be suppressed.

Also, since the oscillation preventing capacitor 6 is provided, even if a low frequency noise lower than a predetermined value f₁ is applied to the power supply voltage V_{CC}, the gain is maintained at an open-loop gain A₀ as indicated by X1 in FIG. 2A which shows the gain characteristics of the voltage regulator 100 of FIG. 1, and the power supply rejection ratio (PSRR) characteristics do not deteriorate as indicated by X1 in FIG. 2B which shows the PSRR characteristics of the voltage regulator 100 of FIG. 1.

In the voltage regulator 100 of FIG. 1, since the circuit current of the differential amplifier 2 is relatively small and the capacitance of the oscillation preventing capacitor 6 is relatively large, the response band as indicated by X1 in FIG. 2A is so narrow that the operation is stable. However, if a high frequency noise higher than the frequency f₁ is applied to the power supply voltage V_{CC}, the gain is decreased as indicated by X2 in FIG. 2A, and simultaneously, the PSRR characteristics deteriorate rapidly as indicated by X2 in FIG. 2B, so that such a high frequency noise cannot be compensated for by the negative feedback control. As a result, such a high frequency noise would appear at the output terminal OUT.

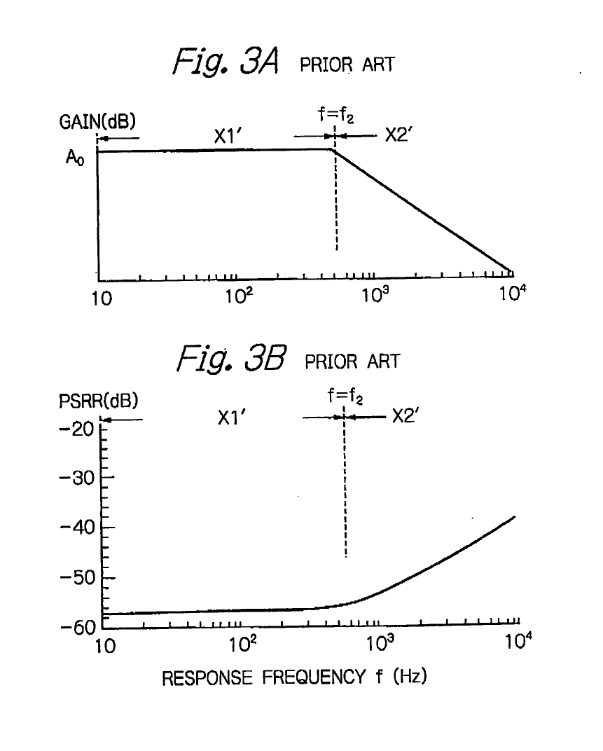

In the voltage regulator 100 of FIG. 1, in order to improve the PSRR characteristics at a higher frequency indicated by X1′ in FIG. 3B, one approach is to increase the circuit current of the differential amplifier 2, and another approach is to decrease the capacitance of the oscillation preventing capacitor 6. In this case, however, the response band is also broadened as indicated by X1′ in FIG. 3A, so that the operation is would be unstable. Also, the former approach would increase the power consumption.

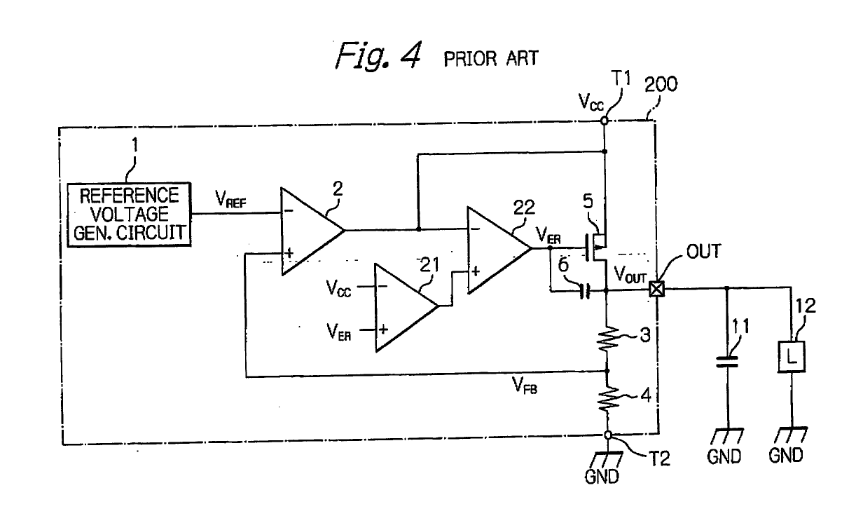

In FIG. 4, which illustrates a second prior art voltage regulator (see: JP-2001-159922-A), a voltage regulator 200 includes differential amplifiers (operational amplifiers) 21 and 22 in addition to the voltage regulator 100 of FIG. 1. As a result, the amplification of a differential amplifier section is increased to improve the PSRR characteristics as shown in FIG. 3B. Even in this case, the response band would be broadened as shown in FIG. 3A. Also, since the number of differential amplifiers (operational amplifiers) is increased, the power consumption would be increased and the circuit size would be increased.

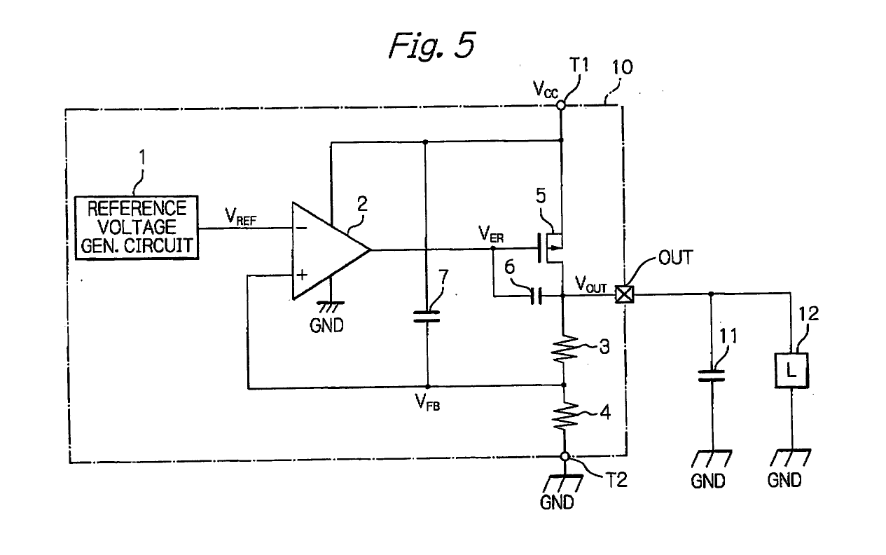

In FIG. 5, which illustrates a first embodiment of the voltage regulator according to the present invention, a voltage regulator 10 includes a capacitor 7 in addition to the voltage regulator 100 of FIG. 1.

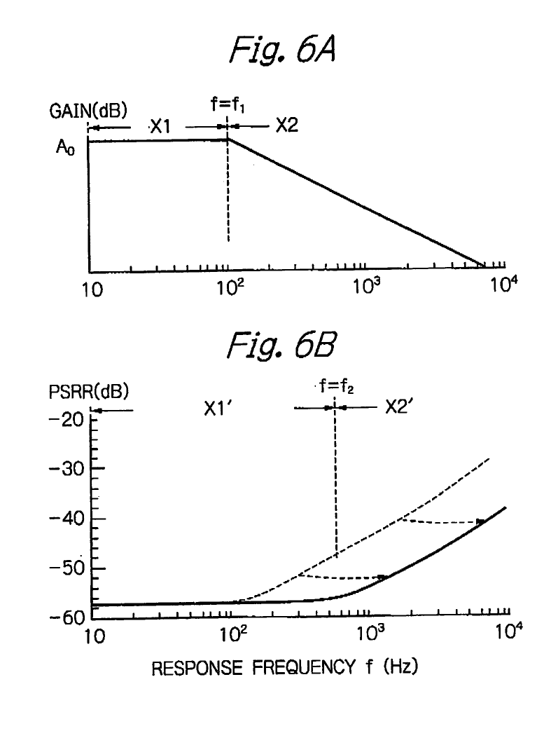

The gain characteristics of the voltage regulator 10 of FIG. 5 are as shown in FIG. 6A where a response band is limited by the oscillation preventing capacitor 6. Note that since the capacitance of the oscillation preventing capacitor 6 is relatively large, an upper frequency f₁ defined by the response band is 80 kHz, for example. Therefore, if a low frequency noise lower than the frequency f₁ is applied to the power supply voltage V_{CC}, the negative feedback control using the feedback voltage V_{FB} is carried out to compensate for the low frequency noise, so that the output voltage V_{OUT} is not affected by the low frequency noise.

On the other hand, the capacitance of the capacitor 7 is determined to pass a high frequency noise higher than the frequency f₁ applied to the power supply voltage V_{CC} therethrough to the input of the differential amplifier 2 which receives the feedback voltage V_{FB}. Therefore, the capacitor 7 does not affect the gain characteristics as shown in FIG. 6A, but the capacitor 7 affects, i.e., improves the PSRR characteristics as shown in FIG. 6B where the PSRR is increased at a frequency f₂ such as 500 Hz higher than the frequency f₁.

As a result, if a high frequency noise having a frequency higher than the frequency f₁ is applied to the power supply voltage V_{CC}, such a noise is superposed onto the feedback voltage V_{FB}, and fed back to the differential amplifier 2, so that the high frequency noise is compensated for.

In the voltage regulator 10 of FIG. 5, since the circuit current of the differential amplifier 2 is relatively small, the power consumption is small.

Thus, since only the capacitor 7 is added to the voltage regulator 100 of FIG. 1, the voltage regulator 10 of FIG. 5 is not so large in size.

In the voltage regulator 10 of FIG. 5, when the resistance of the external load 12 is changed, the gain of the drive P-channel MOS transistor 5 is also changed, so that the response band defined by the frequency f₁ of FIG. 6A is changed. That is, the smaller the resistance of the external load 12, the higher the frequency f₁ of FIG. 6A. Thus, it is preferable that the capacitance of the capacitor 7 is changed in accordance with the resistance of the external load 12, which is realized by the following second, third and fourth embodiments.

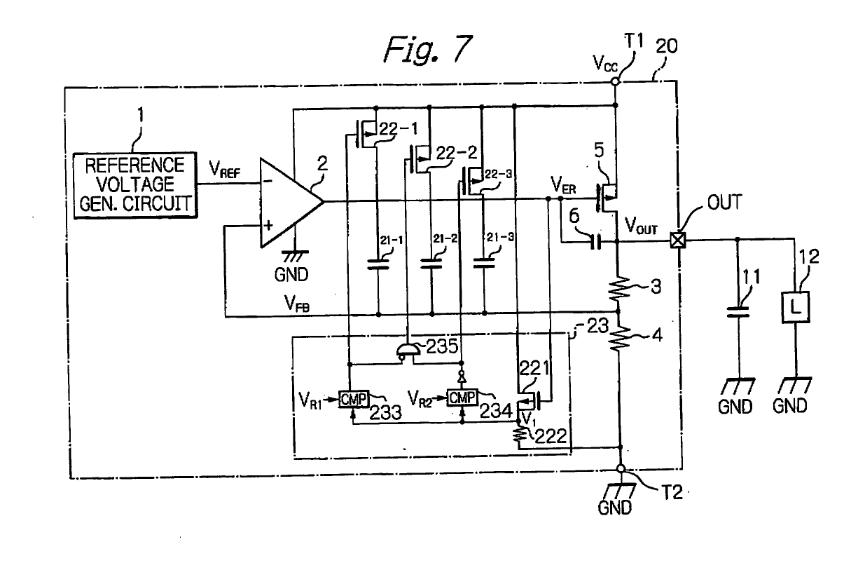

In FIG. 7, which illustrates a second embodiment of the voltage regulator according to the present invention, a voltage regulator 20 includes capacitors 21-1, 21-2 and 21-3 associated with switches formed by P-channel MOS transistors 22-1, 22-2 and 22-3, respectively, and a control circuit 23, instead of the capacitor 7 of the voltage regulator 10 of FIG. 5. In this case, the capacitances C1, C2 and C3 of the capacitors 21-1, 21-2 and 21 are different from each other, i.e.,
C1<C2<C3.

The control circuit 23 is constructed by a voltage detector formed by a P-channel MOS transistor 231 for detecting a source-to-gate voltage of the drive P-channel MOS transistor 5 depending upon the resistance value of the external load 12, a resistor 232 connected to the drain of the P-channel MOS transistor 231, comparators 233 and 234 for comparing a voltage V, between the P-channel MOS transistor 231 and the resistor 232 with reference voltages V_{R1} and V_{R2} (V_{R1}<V_{R2}), and a gate circuit 235. As a result, when V₁<V_{R1}, the switch P-channel MOS transistor 22-1 is turned ON to select the capacitor 21-1. Also, when V_{R1}≦V₁<V_{R2}, the switch (P-channel MOS transistor) 22-2 is turned on to select the capacitor 21-2. Further, when V₁≧V_{R2}, the switch (P-channel MOS transistor) 22-3 is turned ON to select the capacitor 21-3.

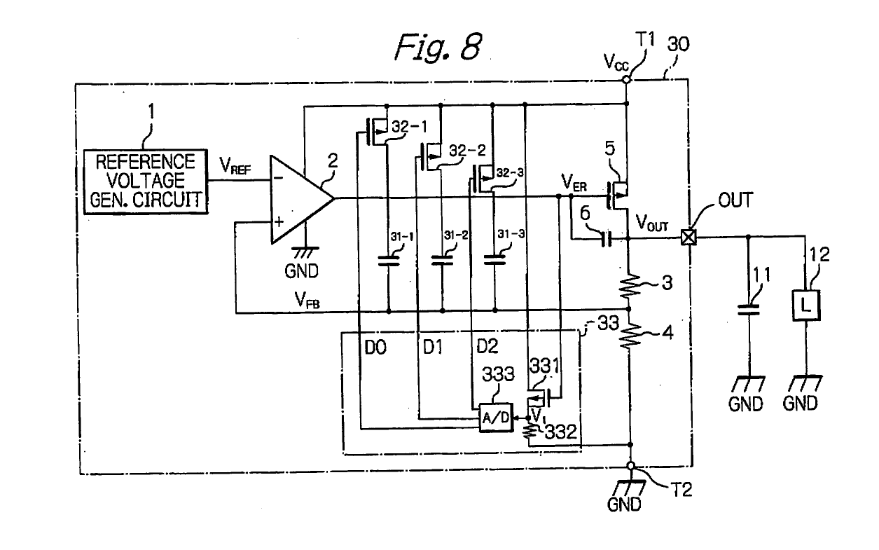

In FIG. 8, which illustrates a third embodiment of the voltage regulator according to the present invention, a voltage regulator 30 includes capacitors 31-1, 31-2 and 31-3, whose capacitances are C₀:2C₀:4C₀, associated with switches (P-channel MOS transistors) 32-1, 32-2 and 32-3, respectively, and a control circuit 33, instead of the capacitor 7 of the voltage regulator 10 of FIG. 5.

The control circuit 33 is constructed by a voltage detector formed by a P-channel MOS transistor 331 for detecting a source-to-gate voltage of the drive P-channel MOS transistor 5 depending upon the resistance of the load 12, a resistor 332 connected to the drain of the P-channel MOS transistor 331, and an analog/digital (A/D) converter 333 for performing an A/D conversion upon a voltage V₁ between the P-channel MOS transistor 331 and the resistor 332 to generate three-bit data (D0, D1, D2). As a result, the switches (P-channel MOS transistors) 32-1, 32-2 and 32-3 are turned ON in accordance with the output signal of the A/D converter 333. For example, if (D0, D1, D2)=(1, 1, 0), only the capacitor 21-2 is selected, so that the capacitance of the entirety of the capacitors 21-1, 21-2 and 21-3 is 2C₀. Also, if (D0, D1, D2)=(1, 1, 1), the capacitors 21-1, 21-2 and 21-3 are selected so that the capacitance of the entirety of the capacitors 21-1, 21-2 and 21-3 is 7C₀ (=C₀+2C₀+4C₀). Note that data (0, 0, 0) is prohibited. Also, each bit “1” of the A/D converter 333 shows a low level, and each bit “0” of the A/D converter 33 shows a high level.

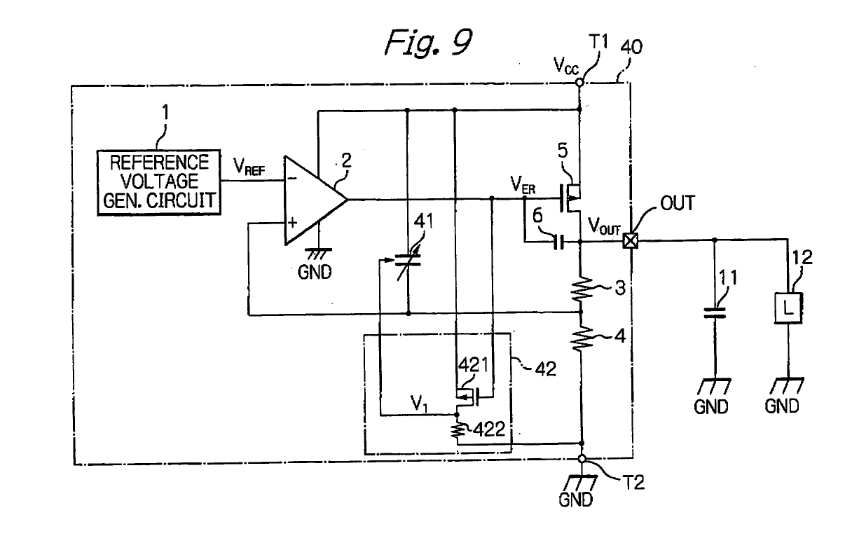

In FIG. 9. which illustrates a fourth embodiment of the voltage regulator according to the present invention, a voltage regulator 40 includes a variable capacitor 41 and a control circuit 42, instead of the capacitor 7 of the voltage regulator 10 of FIG. 5.

The control circuit 42 is constructed by a voltage detector formed by a P-channel MOS transistor 421 for detecting a source-to-gate voltage of the drive P-channel MOS transistor 5 depending upon the resistance of the load 12, a resistor 422 connected to the drain of the P-channel MOS transistor 421. As a result, the capacitance of the variable capacitor 41 is controlled in accordance with a voltage V₁ between the drain of P-channel MOS transistor and the resistor 422.

In FIGS. 7 and 8, the number of capacitors associated with switches can be four or more. Also, in FIGS. 7, 8 and 9, the resistance of the load 12 can be monitored by the power supply voltage V_{CC} and the output voltage V_{OUT} instead of the power supply voltage V_{CC} and the error voltage V_{ER}.

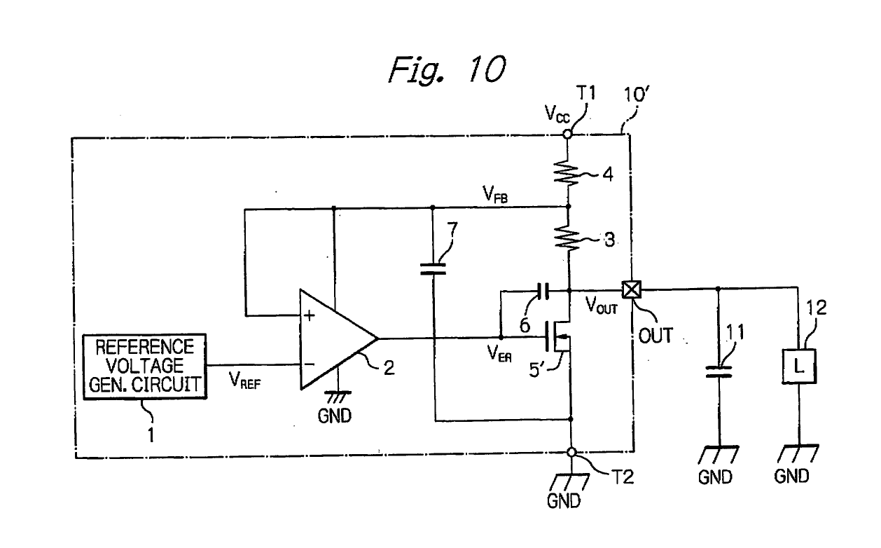

Further, in FIGS. 5, 7, 8 and 9, the drive transistor 5 can be replaced by an N-channel MOS transistor, as illustrated in FIG. 10 which illustrates a modification of the voltage regulator 10 of FIG. 5.

As explained hereinabove, according to the present invention, the PSRR characteristics can be improved while maintaining the narrow response band.

1. A voltage regulator comprising:
first and second power supply terminals;
an output terminal;
a reference voltage generating circuit adapted to generate a reference voltage;
a drive transistor connected between said first power supply terminal and said output terminal, said drive transistor having a control terminal;
a voltage divider connected between said output terminal and said second power supply terminal, said voltage divider adapted to generate a feedback voltage between voltages at said output terminal and said first power supply terminal;
a differential amplifier having a first input connected to said voltage divider, a second input connected to said reference voltage generating circuit and an output connected to the control terminal of said drive transistor, said differential amplifier adapted to generate an error voltage in accordance with said feedback voltage and said reference voltage and transmit said error voltage to the control terminal of said drive transistor;
an oscillation preventing capacitor connected between the control of said drive transistor and said output terminal; and
a capacitor connected between said first power supply terminal and the first input of said differential amplifier.

2. The voltage regulator as set forth in claim 1, wherein a capacitance of said capacitor is determined to pass a noise applied to said first power supply terminal, said noise having a higher frequency than a predetermined value defined by a negative feedback control of said drive transistor, said oscillation preventing capacitor, said voltage divider and said differential amplifier.

3. The voltage regulator as set forth in claim 1, wherein a capacitance of said capacitor is variable, said voltage regulator further comprising a control circuit connected to said capacitor and adapted to change the capacitance of said capacitor in accordance with a resistance of an external load connected to said output terminal.

4. The voltage regulator as set forth in claim 3, wherein said control circuit comprises:
a transistor, connected to said first power supply terminal and the control terminal of said drive transistor, said transistor being adapted to generate a current depending upon the difference in voltage between said first power supply terminal and the control terminal of said drive transistor; and
a resistor connected between said transistor and said second power supply voltage and adapted to generate a voltage for controlling the capacitance of said capacitor in accordance with the current flowing through said transistor.

5. The voltage regulator as set forth in claim 1, wherein said drive transistor comprises a P-channel MOS transistor under the condition that a voltage at said first power supply terminal is higher than a voltage at said second power supply terminal.

6. The voltage regulator as set forth in claim 1, wherein said drive transistor comprises an N-channel MOS transistor under the condition that a voltage at said second power supply terminal is higher than a voltage at said second power supply terminal.

7. A voltage regulator comprising:
first and second power supply terminals;
an output terminal;
a reference voltage generating circuit adapted to generate a reference voltage;
a drive transistor connected between said first power supply terminal and said output terminal, said drive transistor having a control terminal;
a voltage divider connected between said output terminal and said second power supply terminal, said voltage divider adapted to generate a feedback voltage between voltages at said output terminal and said first power supply terminal;
a differential amplifier having a first input connected to said voltage divider, a second input connected to said reference voltage generating circuit and an output connected to the control terminal of said drive transistor, said differential amplifier adapted to generate an error voltage in accordance with said feedback voltage and said reference voltage and transmit said error voltage to the control terminal of said drive transistor;
an oscillation preventing capacitor connected between the control of said drive transistor and said output terminal;
a plurality of capacitors associated with switches, connected between said first power supply terminal and the first input of said differential amplifier; and
a control circuit connected to said plurality of capacitors and adapted to select said plurality of capacitors in accordance with a resistance of an external load connected to said output terminal.

8. The voltage regulator as set forth in claim 7, wherein said control circuit comprises:
a transistor, connected to said first power supply terminal and the control terminal of said drive transistor, said transistor being adapted to generate a current depending upon the difference in voltage between said first power supply terminal and the control terminal of said drive transistor;
a resistor connected between said transistor and said second power supply voltage and adapted to generate a voltage in accordance with the current flowing through said transistor; and
a logic circuit connected to said resistor and adapted to select one of said plurality of capacitors.

9. The voltage regulator as set forth in claim 7, wherein said control circuit comprises:
a transistor, connected to said first power supply terminal and the control terminal of said drive transistor, said transistor being adapted to generate a current depending upon the difference in voltage between said first power supply terminal and the control terminal of said drive transistor;
a resistor connected between said transistor and said second power supply voltage and adapted to generate a voltage in accordance with the current flowing through said transistor; and
an analog/digital converter connected to said resistor and adapted to select at least one of said plurality of capacitors.

10. The voltage regulator as set forth in claim 7, wherein said drive transistor comprises a P-channel MOS transistor under the condition that a voltage at said first power supply terminal is higher than a voltage at said second power supply terminal.

11. The voltage regulator as set forth in claim 7, wherein said drive transistor comprises an N-channel MOS transistor under the condition that a voltage at said second power supply terminal is higher than a voltage at said second power supply terminal.
